(19) United States
(12) Patent Application Publication
(10) Pub. No.: US 2015/0351581 A1
(43) Pub. Date: Dec. 10, 2015

(54) NETWORK CONNECTED COFFEE MAKER FOR PROCESSING A COFFEE PRODUCT

(71) Applicants: Weizhong Li, Guangzhou (CN); Yewu Zhong, Guangzhou (CN)

(72) Inventors: Weizhong Li, Guangzhou (CN); Yewu Zhong, Guangzhou (CN)

(21) Appl. No.: 14/424,142

(22) PCT Filed: Jun. 6, 2014
(86) PCT No.: PCT/CN2014/079421

§ 371 Date: Feb. 26, 2015

(51) Int. Cl. A47J 31/44; A23F 5/26; A47J 31/40; A47J 31/56; G05B 15/02; H04W 4/00

(52) U.S. Cl. CPC A47J 31/4403; G05B 15/02; H04W 4/008; A47J 31/407; A47J 31/56; A23F 5/26

(57) ABSTRACT

The invention provides a method and a coffee maker for processing a coffee product. The coffee maker comprises a coffee product processing means, a communications module connecting said coffee maker to a communications network, a memory storing an application program, and a processor configured to execute said application program to enable said coffee maker to exchange information through said communications network with any one or any combination of: a server; a database; a network connected device, another coffee maker or a group of other coffee makers for processing a coffee product The processor is configured to control said coffee product processing means to process the coffee product based on information received over said network as a consequence of said exchange of information. The coffee product preferably comprises a ground coffee powder filled capsule and the coffee maker preferably comprises means for filling a blank capsule with a ground coffee powder and sealing said filled capsule ready for processing by said coffee product processing means.

### TECHNICAL FIELD

The invention relates to a network connected coffee maker for processing a coffee product.

### BACKGROUND ART

Coffee makers are often supplied with control instructions for operating the coffee maker efficiently. The control instructions may set out preferred or optimized sets of control parameters provided by the coffee maker manufacturer for processing a coffee product, but may also allow a user to input their own preferred control parameters according to experience and taste.

One significant problem with such appliances is that the above mentioned coffee products are complex products which vary widely in how they are best processed according to multiple factors including brand, type, quality and year of production, not forgetting other complicating factors or characteristics such as processing temperature and pressure, etc. The possible permutations of the multiple factors leads to what may be considered as an overwhelming selection of competing or alternative control options or sets of control parameters for a user of the appliance to select from. Another problem is that users will often only learn about different control parameter options though use of the appliance by trial and error. For coffee, the roast style of the coffee bean has a significant impact on taste. Furthermore, the grind quality, i.e. grind size, of the coffee grounds also has a significant effect on the type, taste and quality of consumable coffee drink produced from the coffee maker appliance.

### DISCLOSURE OF INVENTION

### Technical Problem

An object of the invention is to mitigate or obviate to some degree one or more problems associated with known coffee makers for processing coffee products.

The above object is met by the combination of features of the main claims; the sub-claims disclose further advantageous embodiments of the invention.

Another object of the invention is to provide a user of a coffee maker with access to knowledge from any of producers, suppliers, distributors or sellers of coffee products.

Another object of the invention is to provide a user of a coffee maker with access to knowledge from other users of similar or the same coffee makers.

One skilled in the art will derive from the following description other objects of the invention. Therefore, the foregoing statements of object are not exhaustive and serve merely to illustrate some of the many objects of the present invention.

### Solution to Problem

### Technical Solution

In a first main aspect, the invention provides a. coffee maker for processing a coffee product, comprising: a coffee product processing means; a communications module connecting said coffee maker to a communications network; a memory storing an application program; a processor configured to execute said application program to enable said coffee maker to exchange information through said communications network with any one or any combination of: a server; a database; a network connected device, another coffee maker or a group of other coffee makers for processing a coffee product; wherein said processor is configured to control said coffee product processing means to process the coffee product based on information received over said network as a consequence of said exchange of information.

In a second main aspect, the invention provides a method of processing a coffee product in a network connected coffee maker comprising the steps of: connecting said coffee maker to a communications network; exchanging information through said communications network with any one or any combination of: a server; a database; a network connected device, another coffee maker or a group of other coffee makers for processing a consumable product of a same general class or type of consumable product; controlling a coffee product processing means of the coffee maker to process the coffee product based on information received over said network as a consequence of said exchange of information.

In a third main aspect, the invention provides a computer readable medium storing machine readable instructions which, when implemented on a processor of a network connected coffee maker, implements the steps of the method of the second main aspect of the invention.

In a fourth main aspect, the invention provides a cup for use with the coffee maker of the first main aspect of the invention, wherein said cup has means for wirelessly communicating with the coffee maker.

The summary of the invention does not necessarily disclose all the features essential for defining the invention; the invention may reside in a sub-combination of the disclosed features.

### BRIEF DESCRIPTION OF DRAWINGS

### Description of Drawings

The foregoing and further features of the present invention will be apparent from the following description of preferred embodiments which are provided by way of example only in connection with the accompanying figures, of which:

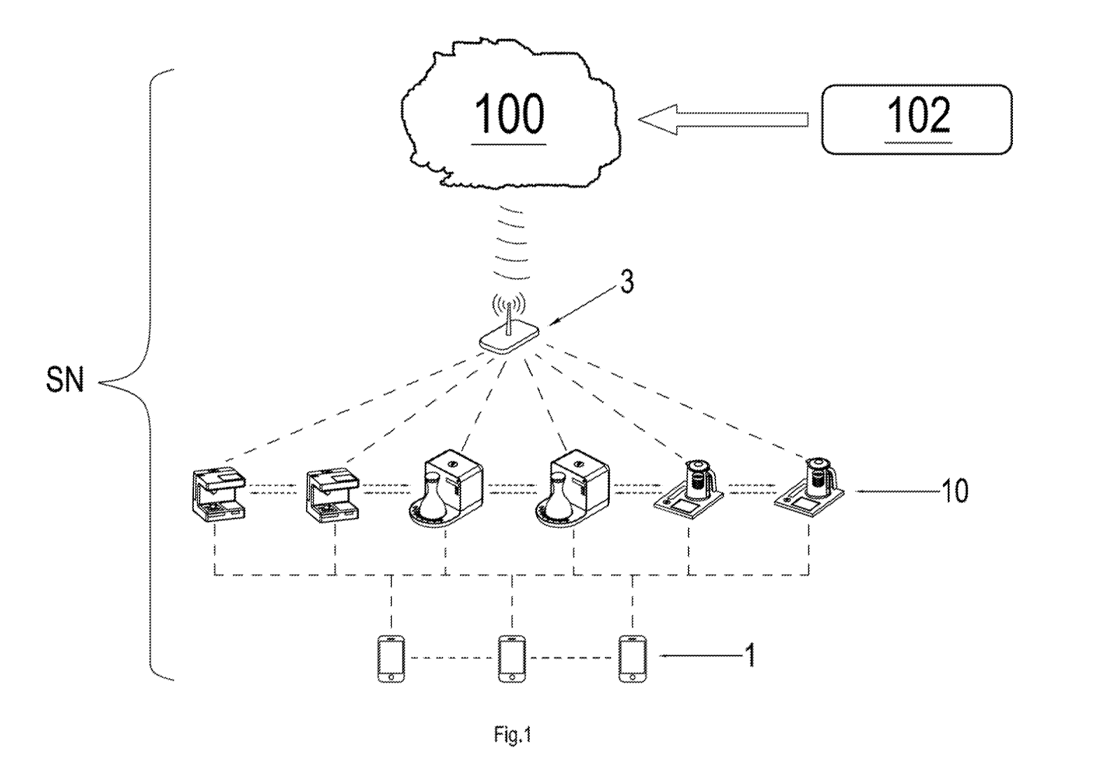

FIG. 1 is a block schematic diagram of a social network of domestic appliances for processing consumable products;

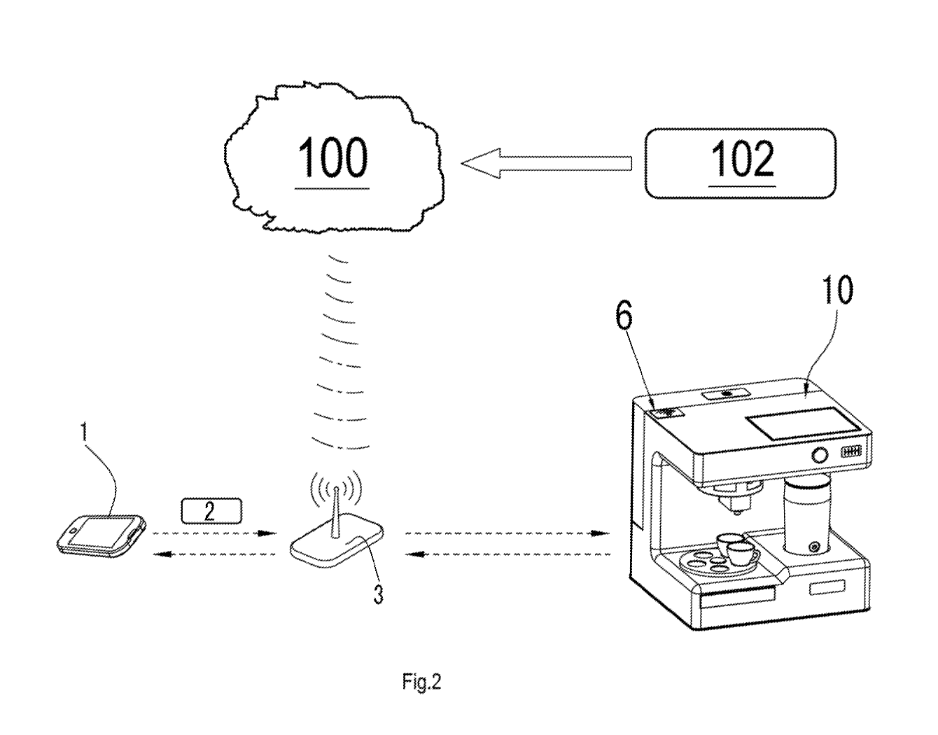

FIG. 2 is a block schematic diagram of a network connected coffee maker according to the invention;

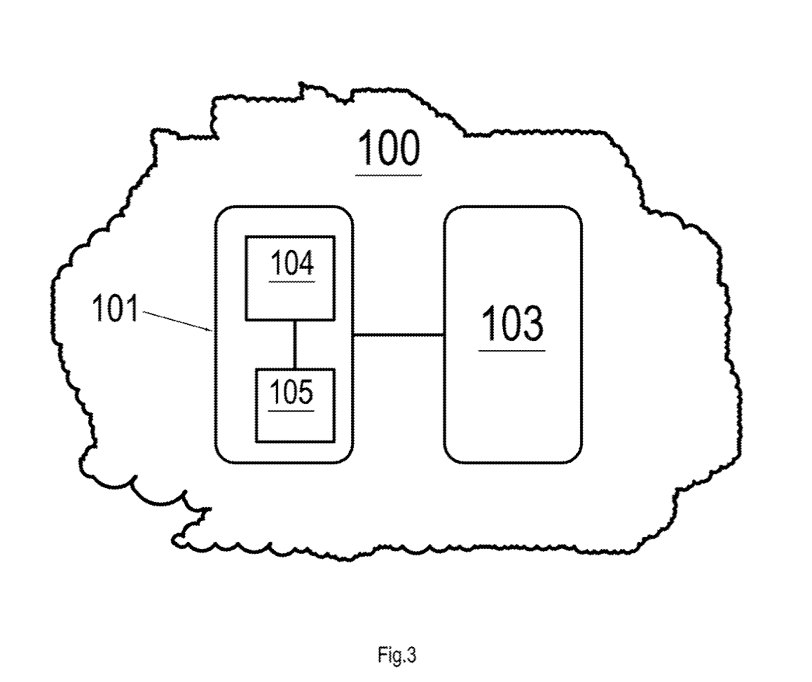

FIG. 3 is a schematic diagram of a network to which the coffee maker of FIG. 2 is connected;

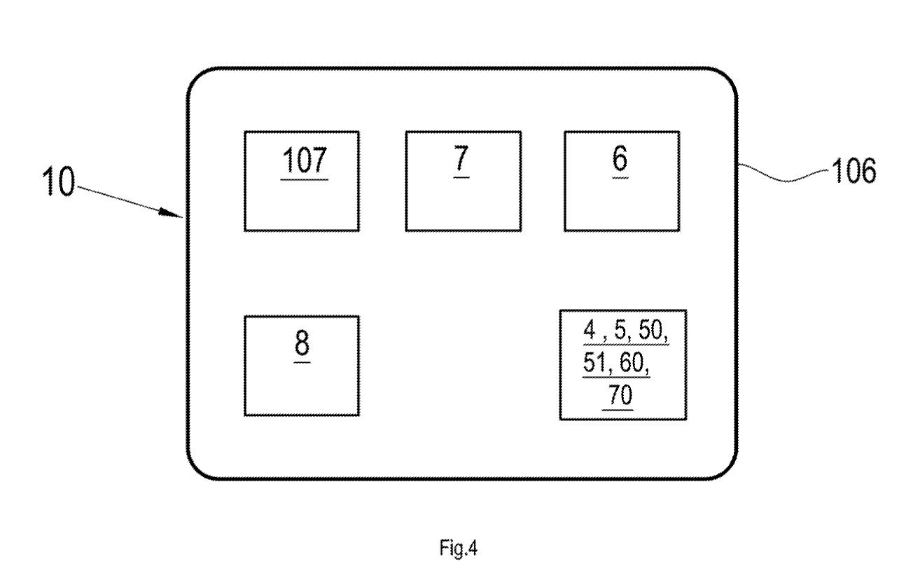

FIG. 4 is a block schematic diagram of a coffee maker according to the invention;

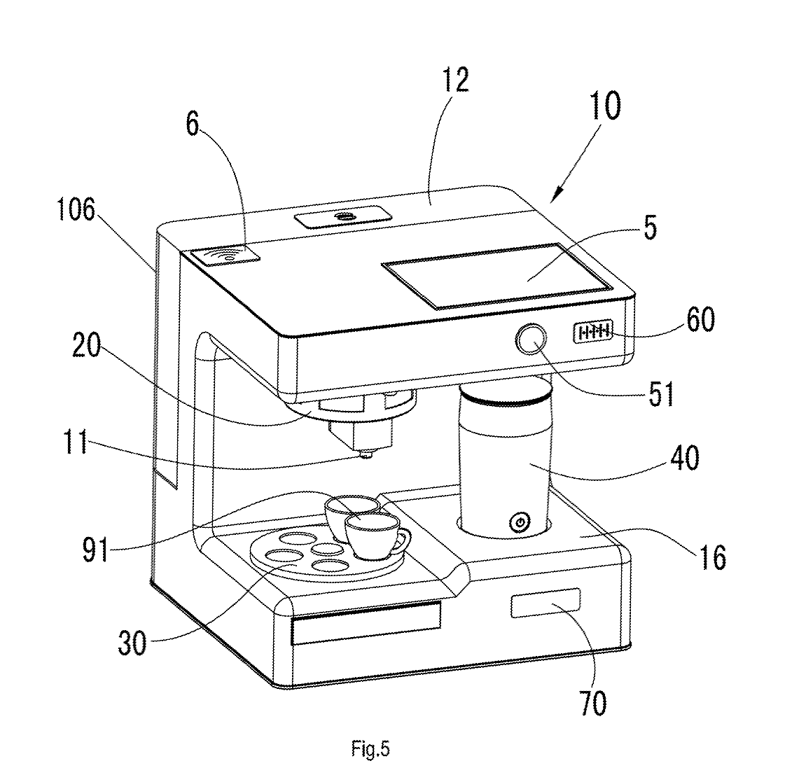

FIG. 5 is a perspective front view of a coffee maker according to the invention;

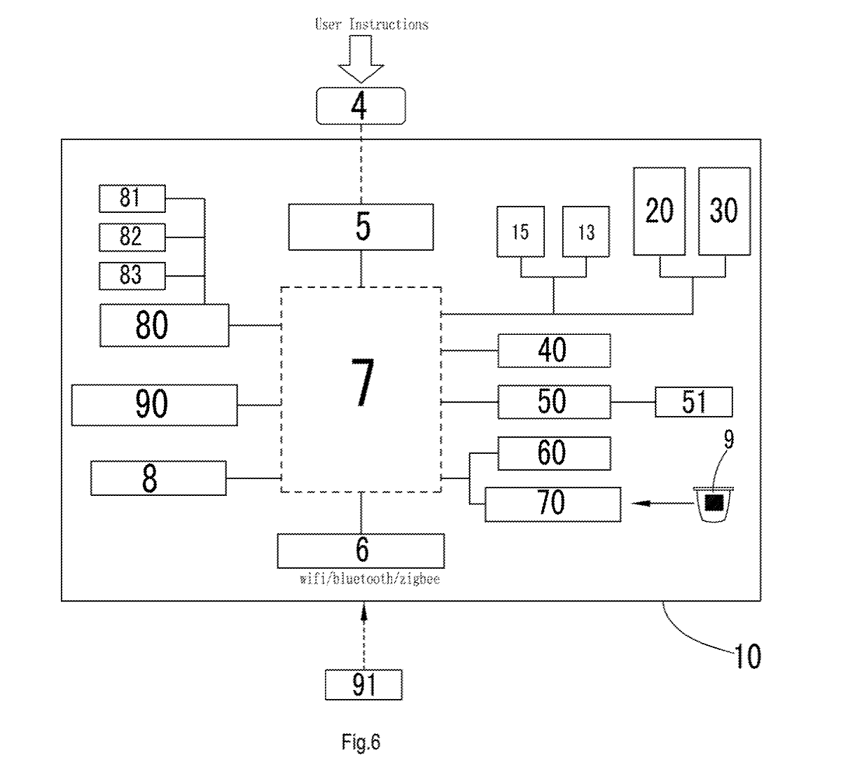

FIG. 6 is a more detailed block schematic of the coffee maker of FIG. 5;

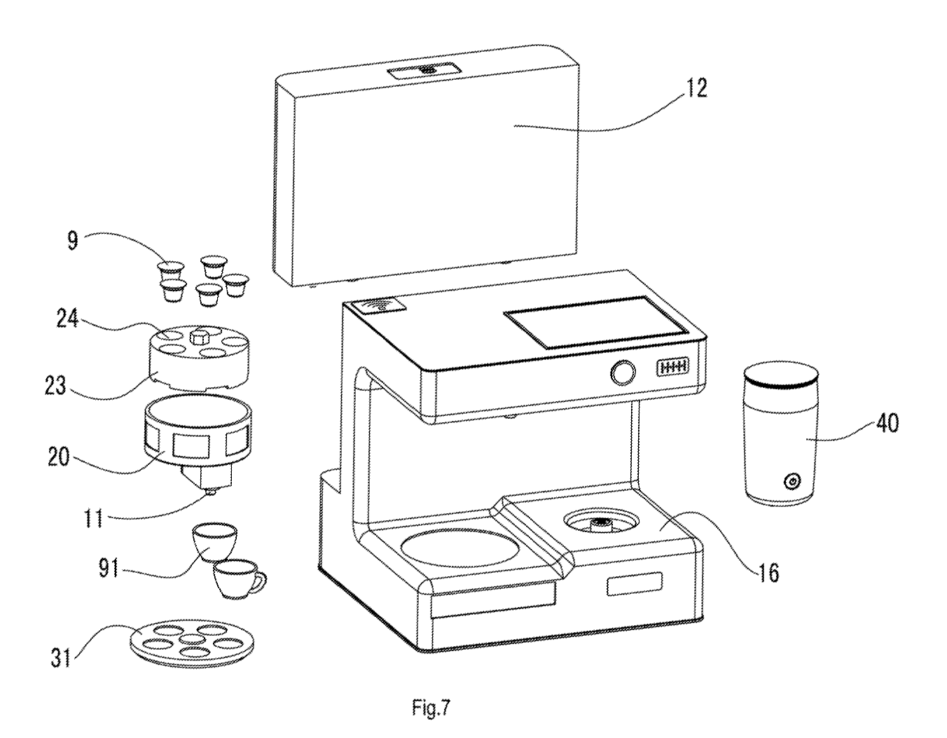

FIG. 7 is an exploded perspective view of the coffee maker of FIG. 5;

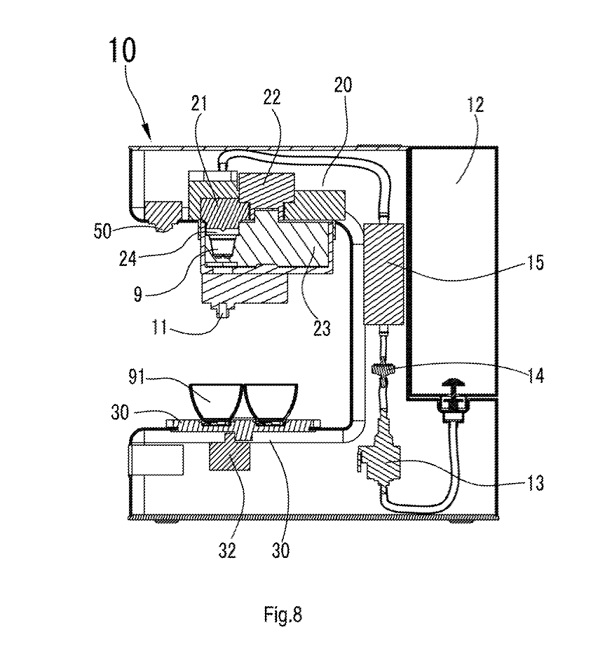

FIG. 8 is a first side sectional view of the coffee maker of FIG. 5;

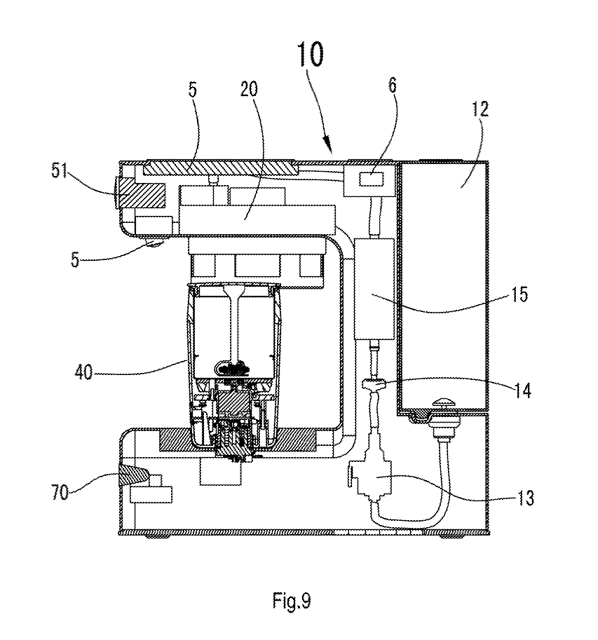

FIG. 9 is a second side sectional view of the coffee maker of FIG. 5; and

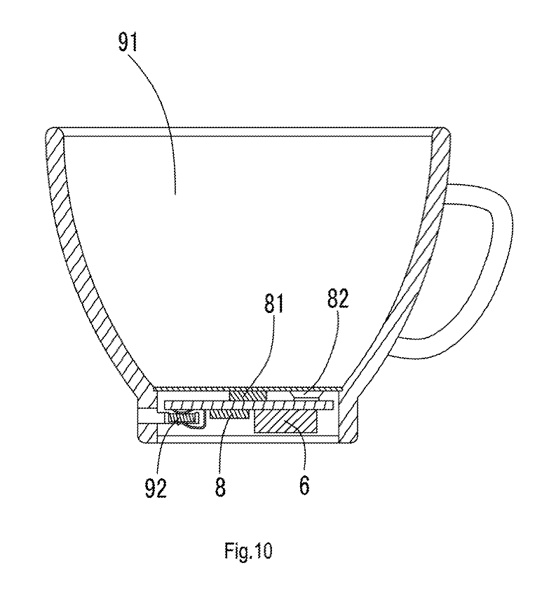

FIG. 10 is a side sectional view of a coffee cup for use with the coffee maker of the invention.

### MODE FOR THE INVENTION

### Mode for Invention

The following description is of preferred embodiments by way of example only and without limitation to the combination of features necessary for carrying the invention into effect.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

It should be understood that the elements shown in the FIGS., may be implemented in various tonus of hardware, software or combinations thereof. Preferably, these elements are implemented in a combination of hardware and software on one or more appropriately programmed general-purpose devices, which may include a processor, memory and input/output interfaces.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. It is thus regarded that any means that can provide those functionalities are equivalent to those shown herein.

Referring to FIG. 1, shown is a block schematic diagram of a social network ‘SN’ of domestic appliances 10 for processing consumable products. The social network SN comprises a plurality of appliances 10 connected to a communications network 100 through a wireless router 3. Whilst FIG. 1 shows all of the appliances 10 connected through the same wireless router 3, it will be understood that the appliances 10 may be separately connected to the network 100 through their own dedicated or shared wireless routers 3 or through any other suitable wired or wireless network connection means such as Ethernet cables.

Whilst the communications network 100 preferably comprises a CLOUD network, it will be understood that the network 100 may comprise any communications network, private and/or public, which enables network enabled appliances 10 to be able to communicate through the network 100 with each other, with network based devices and with other devices connected to the network 100.

It will also be understood that, in some embodiments, only appliances 10 adapted for processing a coffee product will be authorized to connect to the network 100.

Each appliance 10 in the social network SN is configured to execute a social network application 2 hosted by a server 101 (FIG. 3) whereby users of the appliances can exchange social media messages with each other through the network 100.

A plurality of third party entity devices 102 are connected to the network 100. Each third party entity device 102 is preferably also a network enabled appliance 10, but could comprise any network enabled device 102 which allows data to be uploaded to the server 101. Each third party entity preferably comprises a producer of the consumable product, but may comprise any of a supplier, distributor or seller of the coffee product or of the means for making the coffee product.

The appliances 10 may also be enabled to communicate wirelessly with handheld electronic processing devices 1 such as smart phones or tablet computers or even to communicate with personal computers (PCs) or the like (not shown) to receive and/or share other parameters or information relating to the consumable product.

Referring to FIG. 2, shown is a social network 1 based on a plurality of coffee makers 10 for processing a coffee product. The coffee product may comprise coffee beans or ground coffee to make a coffee drink, but may comprise a sealed coffee capsule filled with ground coffee powder.

Whilst only one coffee maker 10 is shown connected to the communication network 100, it will be understood that a plurality of such appliances 10 may be connected to the network 100 and that said appliances 10 may be located in geographically diverse regions as afforded by the coverage of the network 100. It will also be understood that other types of appliances as depicted in FIG. 1 may also be connected to the network 100, although, preferably, only coffee makers 10 of a same or similar type, i.e. from a same manufacturer of coffee makers, are authorized to connect to the network 100 to thereby restrict the social network to such coffee makers 10.

As is best seen in FIG. 3, the network 100 has a network based server 101 and a database 103 under control of the server 101. The server 101 comprises at least one processor 104 and at least one memory 105. The server memory 105 stores machine code which, when executed by the processor 104, implements the server based methods of the invention as described herein. Whilst the database 103 is shown as a separate network based device to the server 101, it will be understood that, the server 101 may host the database 103 in some embodiments. It will also he understood that the network 100 may include, in some embodiments, a plurality of network connected servers 101 and databases 103 and that these may be located at geographically diverse locations, in. some embodiments, the plurality of servers 101 and databases 103 may be associated with respective third party entities.

The communications network 100 may comprise or include the public internet or may comprise a virtual private network (VPN) hosted by public communication networks such as the internet.

Access to the network 100 may in some embodiments, be restricted to only networked enabled coffee makers 10, 102 as herein described. Access to the network 100 may also be restricted by means of authenticating appliances 10, 102 attempting to connect to the server 101. Consequently, in some embodiments, the community of devices 10, 102 which can connect to the network 100 is restricted to coffee makers which have embedded therein suitable authentication software and suitable authentication codes to provide access to the restricted access network 100. In this way, the network 100 is restricted to a community of users of authorized coffee makers 10, 102 which are adapted to process coffee products.

FIG. 4 is a schematic block diagram of a coffee maker 10. The coffee maker 10 comprises a housing 106 containing a coffee product processing means 107; a central control unit 7 for controlling the coffee product processing means 107 to process the consumable product according to one or more control parameters to provide a coffee drink for consumption, a communications module 6 connecting said appliance 10 to the communications network 100, a memory or data storage module 8 storing an application program, and at least one input, interface 4, 5, 50, 51, 60, 70 which preferably includes a touch screen 5. The processor 7 is configured to execute said application program to enable said appliance 10 to exchange information through said communications network 100 with any one or any combination of the network server 101, the network database 103, or another coffee maker 10, 102.

Referring again to FIG. 2, the communications module 6 of the coffee maker may be WiFi™ enabled to allow the coffee maker 10 to connect to the network 100 via a wireless connection through the wireless router 3, but it will be understood that the coffee maker 10 may connect to the network 100 through any suitable wireless or wired means including an Ethernet connection.

Referring to FIGS. 5 to 10, the structure of a coffee maker 10 in accordance with the invention is shown in greater detail The coffee maker 10 comprises a housing 106 accommodating a wireless communication module 6 for enabling the coffee maker to connect to the network 101, a plurality of input devices or interfaces including a user interface 4, a touch screen 5, a camera module 50, a face recognition module 51, a voice recognition module 60, and a bar code or QR code scanning module 70. The input modules enable a user to manually or automatically input information into the coffee maker 10 for various functions including as content of messages to be shared with other network connected devices 10, 102 including other coffee maker appliances 10 whereby users of said appliances 10 can share information. For example, the QR scanning code module 70 may be adapted to read bar codes, QR codes or any other form of printed code on the packaging, label or the like of the coffee product in order to obtain information concerning the identity of the product and one or more of its characteristics as hereinafter described. The voice recognition module 60 may have the dual functions of enabling a user to enter spoken information concerning a coffee product into the appliance 10 and to recognize a specific user's voice in order that any use of the appliance is recorded for that. user. In this way, the appliance can offer an individual user experience to each user even though a plurality of users utilizes the same appliance. The camera module 50 may be adapted to interoperate with the face recognition module 51 to recognize individual users of the appliance 10 as well as to recognize information, written or pictorial, or other indicia which, enable the appliance 10, either by itself or in cooperation with the server 101, to derive information about the identity of a coffee product and one or more of its characteristics.

The coffee maker 10 also includes a processor in the form of a central control unit 7, at least one memory in. the form of a data storage module 8 and an information acquisition module 80 which is specifically tasked with receiving and storing information received at any of the input devices or interfaces relating to the coffee product a user wishes to process on the appliance 10 or wishes to receive more information about for enhancing processing of that coffee product in the appliance 10. Information acquired by the information acquisition module 80 may be processed by the information interaction module 90 in communication with similar such modules 90 of other network connected coffee makers 10.

The coffee maker 10 includes a water supply system comprising a water tank 12, a pump 13, a one way valve 14 and a heating device 15 which feeds heated water under pressure to the coffee product, processing means 107,

The coffee product processing means 107 includes an automatic rotary coffee capsule receiving or filling device 20 having a motor 22 for driving a rotating coffee capsule support plate 23 having a plurality of cavities 24 for receiving coffee capsule cups 9. Also included is a device 21 for loading prefilled coffee capsules from a cartridge (not shown) into respective cavities 24 of the support plate 23 or loading empty coffee capsule cups 9 into the cavities 24 of the support plate ready for filling with a charge of ground coffee powder. In this latter embodiment, the coffee product processing means 107 may include one or more coffee powder hoppers (not shown) for delivering respective controlled charges of coffee powder to each of the coffee capsule cups. Once the capsule cups are filled, they are sealed with an aluminum foil cover which is heat sealed or adhered to the rim of the capsule cup 9. In this latter embodiment the coffee maker may be controlled by a user or by information received over the network 100 to fill a capsule cup with a specified blend of coffee powders from the different hoppers in different percentage or weight amounts. The coffee maker may also include a laser or ink print device for marking a capsule cup or its foil seal with an indication of the blend of powders placed in a capsule cup 9. The coffee capsule receiving or filling device 20 has a coffee drink outlet 11.

Below the coffee drink outlet 11 is provided a support plate 30 of the coffee maker 10 which supports a rotary cup holder 31 with cavities for a plurality of cups 91. Thus, in operation, as each coffee, capsule 9, prefilled or once filled, is processed in the coffee product processing means 107, the coffee drink drains into a respective cup 91 on the rotary cup holder 31 which is driven by a motor 32.

in some embodiments of the coffee maker 10, a milk frothing device 40 is provided on a base plate 16. The base plate 16 provides a power connector for the frothing device 40.

In some embodiments, the cups 91 are adapted to communicate wirelessly with the coffee maker 10, particularly when said cups 91 are received in the rotary cup holder 31. Each cup has a wireless communications module 6 and a data storage module 8. Each cup 91 may also have a temperature sensor 81, a liquid level sensor 82 and a pressure sensor 83. A battery 92 is provided to power the components of the cup 91. Information provided by the cup's sensors 81, 82 and 83 may be communicated to the information acquisition module for processing by the information interaction module.

One function of the cup 91 may be to identify a user of the cup 91 to the coffee maker. As such, the cup 91 may be updateable wirelessly to receive in its data storage module 8 the identity of a user of the cup 91 and an identifier of the cup 91 itself.

One method of the invention enables third party entities 102 such as producers, suppliers, distributors and sellers of coffee products to upload information about the coffee products to the server 101 such that this information is accessible by users of as the coffee makers 10. In order to make the information accessible to users of coffee makers 10, the information is stored by the server 101 in the database 103 in association with an identity of the coffee product and/or one or more characteristics of the coffee product. For example, an identity of the coffee product may comprise its brand name and/or the name of its manufacturer, distributor, supplier or seller. It is necessary that the identity is unique to avoid conflict between product information from different third party entities. In some embodiments, the server may be enabled to associate a unique identifier with each third party entity authorized to upload data to the network 100.

The one or more characteristics of the coffee product may comprise one or more of the type of the coffee bean or ground coffee, its roast type, its grind size, its year or date of production.

It is envisaged that each third party entity will upload a preferred or optimized set of control parameters for each permutation of its coffee products' identities and/or characteristics where said sets of preferred or optimized control parameters are preferred or optimized specifically for the coffee maker device 10. As such, it is envisaged that the third party entity will be supplied with at least one such coffee maker appliance 10 to enable said third party entity to experiment with its coffee products to derive the preferred or optimized sets of control parameters. This device may also be used by the third party entity to upload data to the server 101.

It will be understood that the number of preferred or optimized sets of control parameters received by the server 101 will grow enormously given the range of permutations of third party entities involved in the production, supply, distribution or sale of coffee products and the variations within those products from each third party entity. Furthermore, as the characteristics of many consumable products are affected by climate, growth conditions or the like, the products characteristics may change over time, e.g. by year, leading to a further escalation in the number of preferred or optimized sets of control parameters received by the server 101. Consequently, the scale of the preferred or optimized sets of control parameters is such that a user of a coffee maker 10 or similar consumable product processing appliance would have to expend considerable time in locating such information if it were not accessible in accordance with the method of the invention where such information is stored in a single network system and whereby, as will be explained below, the information can be automatically retrieved to a user's coffee maker 10 with minimal effort by a user.

It will be understood that, whilst one thrust of the invention is to facilitate the uploading of preferred or optimized sets of control parameters to the server 101 by authorized third party entities, the third party entities 102 may be authorized to share other information relating to their products and to post advertisements and to make available product offers to users.

It will also be understood that the uploading of information is an ongoing process for the third party entities to maintain their product information and sets of control parameters current.

The control parameters for a coffee product may comprise one or more of grind size, ground coffee dose per water amount, water temperature, water pressure and time dependent on the one or more of the identity, brand, coffee bean type, roast type, coffee drink type.

A user of a coffee maker 10 may manually input information through one or more of the various input interfaces 4, 5, 50, 51, 60, 70 of the coffee maker 10 identifying the coffee product and/or one or more characteristics of said coffee product.

In response to manually or automatically receiving product information, the appliance 10 automatically sends data relating to said information to the server 101. The server 101, upon receiving such data, processes it to retrieve the product information and to then retrieve a preferred or optimized set of control parameters for sending to the coffee maker 10.

The step of manually inputting information relating to the coffee product or automatically recognizing information relating to the coffee product from the packaging or an image of the product may not occur entirely within the coffee maker 10. In preferred embodiments, data relating to initial product information received at the coffee maker 10 is automatically sent to the server 101 which processes the data to determine at least some of the product information which uniquely identifies the product and uses this to retrieve from the database 103 full product information which is then sent to the coffee maker 10. The received full product information (including characteristics) is displayed to the user of the coffee maker on the screen or display 5 and the user is invited to confirm said product information or make changes or corrections to it. In the event that the user makes changes, the step of identifying full product information may be repeated until the user confirms the displayed information. Once a user confirmation is received, the coffee maker 10 automatically sends data comprising said confirmation to the server 101 which then retrieves the preferred or optimized set of control parameters for the identified coffee product/characteristics.

The set of preferred or optimized control parameters received at the coffee maker 10 may be used to automatically control the coffee maker 10 including filling coffee capsule cups 9 with blend recipes retrieved by the server 101 or provided by other users over the social media network SN. Alternatively, the set of control, parameters may be displayed to a user and the user invited to confirm, the set of parameters or to make changes thereto prior to operation of the appliance 10 to make coffee. The set of control parameters, whether modified or not by the user, are stored in the memory of the coffee maker 10. The set of control parameters, whether modified or not, may be stored in association, with an identity of a user of the coffee maker 10. This is desirable where a number of different users utilize the same coffee maker 10 who each may have different preferences.

Where a set of control parameters, whether modified or not, is stored in the appliance 10 in association with a unique identity and/or some unique characteristics of the coffee product, this set of control parameters can be retrieved from the data storage module 8 of the coffee maker 10 when next the identified user or another user inputs or presents the same coffee product information at the coffee maker 10 thereby negating the need to contact the server 101 for a preferred or optimized set of control parameters for the coffee product. Once again, the set of control parameters may be displayed to the user on the screen or display 5 for confirmation or modification. In the case where the subsequent user of the coffee maker 10 is another user rather than the original user then any modifications made by said another user may be stored in the memory of the coffee maker in association with said another user.

Where a user has modified a set of control parameters for a coffee product, the user's modifications, changes or adjustments to the set of control parameters may be automatically communicated by the coffee maker to the server 101 and/or to a third party entity device 102 where the third party entity is identified as being associated with the coffee product. The coffee maker 10 may also be configured to communicate such changes together with the coffee product information to a selected user of another appliance 10 or to a selected group of other users where said selection of such other user or users is provided by the user of the coffee maker appliance 10 sending the information.

The third party entity may process users' changes to the sets of preferred or optimized parameters to change or update said sets of preferred or optimized parameters.

The server 101 may be configured to run analytical software to characterize users' changes and to publish its analysis of the changes to user appliances 10. Publication may be selectively targeted at. those users known to have used a particular coffee product. The server 101 may be configured to monitor social media message exchanges between users of the coffee machines and to identify in said messages new or modified sets of control parameters or new or modified recipes for specific brands or types of coffee and to make such information available to users of the coffee maker appliances. Such information may be made available when a user of an appliance uses their coffee maker to process a certain brand or type of coffee product whereby, the server on receiving information from the user's coffee maker, publishes the new or modified information to the user, i.e. sends said information or a notification of the existence of said information to the user's appliance for display to the user on the screen 5 of the appliance.

The application program 2 executed by the central control unit 7 of the coffee maker 10 is as already described a social networking application hosted by the server 101 which enables a user of said appliance 10 to exchange information through said communications network 100 with any one or any combination of: the server 101; a third party entity network device 102; another appliance 10; or a user selected subset of all network connected appliances 10. The social networking application also allows users of coffee makers 10 to share other information with each other which may not be related to coffee products, but the primary purpose of the social networking application is to facilitate a community having a shared interest in a particular consumable product and to share and have access to knowledge about said product, in a manner which is easily accessible and efficient compared to other means of accessing information.

The coffee maker 10 may be configured to seek a user's feedback after a user has used the appliance 10 to make a coffee drink. This may comprise receiving a user's rating information for the product to be consumed and to send said rating information to any one or any combination of: the server 101; a third party entity network device 102; another appliance 10; or a user selected subset of all network connected appliances 10. The server 101 may be configured to publish rating information for coffee products and to display the (modified or updated) sets of control parameters for an identified coffee product in order of greatest ratings. In this embodiment, the server 101 may communicate a list of best rated sets of control parameters to a coffee maker appliance 10 and send the set of control parameters in response to a user's selection of one from the list of best rated sets of control parameters for a specific product.

It will be appreciated that there may be some overlap between the control parameters and the characteristics of a coffee product. For example, where a coffee maker 10 is provided with a coffee grinder to grind coffee beans into powder, one control parameter may comprise the preferred or optimized grind size which the appliance 10 should implement. In contrast, where a coffee maker does not have a grinder but is adapted to process already ground coffee, a characteristic of the coffee product for determination of a preferred or optimized set of control parameters may comprise the grind size of the coffee product the user intends to use in the appliance 10.

In another aspect of the invention, the data collected in the server 101 about users. their tastes and/or preferences may be provided under license, subscription or some other condition for use by the third party entities on improving their products, targeted marketing of their products, educating users on their products, or generally advertising their products. The server 101 may collect data about each user of a coffee maker 10 charting their drinking habits, their product preferences, and/or their usage of the coffee maker 10 and make this data available to third party entities for targeted marketing of their products, education about their products, providing users with recommended product packages or recommended product recipes or blends, or generally advertising their products. The server 101 may be configured to ‘sniff’ data about users' drinking habits, product preferences, and/or usage of the coffee maker 10 from social media message exchanges between users and/or from other messages or requests sent by the users to the server 101. Where the server 101 is configured to host a shopping channel to enable users to purchase coffee products, the server 101 again maintains data relating to the users' purchases as part of the data records for said users.

In another aspect of the invention, third party entities may be permitted to host any of their own; online workshops, chat rooms, blogs, forums, webinars, etc. concerning their products. Data collected from these activities is shared with the server 101 to enhance its data records for the users.

In general, the invention provides a method and a coffee maker for processing a coffee product. The coffee maker comprises a coffee product processing means, a communications module connecting said coffee maker to a communications network, a memory storing an application program, and a processor configured to execute said application program to enable said coffee maker to exchange information through said communications network with any one or any combination of: a server; a database; a network connected device, another coffee maker or a group of other coffee makers for processing a coffee product. The processor is configured to control said coffee product processing means to process the coffee product based on information received over said network as a consequence of said exchange of information. The coffee product preferably comprises a ground coffee powder filled capsule and the coffee maker preferably comprises means for filling a blank capsule with a ground coffee powder and sealing said filled capsule ready for processing by said coffee product processing means.

1-26. (canceled)

27. A coffee maker for processing a coffee product, comprising:
a coffee product processing means;
a communications module connecting said coffee maker to a communications network;
a memory storing an application program;
a processor configured to execute said application program to enable said coffee maker to exchange information through said communications network with any one or any combination of: a server; a database; a network connected device, another coffee maker or a group of other coffee makers for processing a coffee product;
wherein said processor is configured to control said coffee product processing means to process the coffee product based on information received over said network as a consequence of said exchange of information.

28. The coffee maker of claim 27, wherein the coffee maker comprises means for filling a blank capsule with a ground coffee powder and to sealing said filled capsule ready for processing by said coffee product processing means.

29. The coffee maker of claim 27, wherein the coffee product processing means comprises means for piercing said seal of the coffee capsule and passing heated water under pressure through the coffee powder contained in said coffee capsule.

30. The coffee maker of claim 29, wherein said information received over said network as a consequence of said exchange of information comprises a set of control parameters for controlling the water temperature and/or pressure applied by the coffee product processing means.

31. The coffee maker of claim 29, wherein said information received over said network as a consequence of said exchange of information comprises a set of control parameters for controlling any one or more of: the amount of ground coffee powder placed in the capsule; a blend of coffee powders place in said capsule according to a recipe contained in said received information; and other drink powders placed in said capsule.

32. The coffee maker of claim 27, further comprising:
a memory storing an application program; and
a processor configured to execute said application program to enable said coffee maker to exchange information through said communications network with any one or any combination of: the server; the database; a network connected device, another coffee maker or a group of other coffee makers.

33. The coffee maker of claim 32, wherein the application program, executed by said processor is a social networking application which enables a user of said coffee maker to exchange information through said communications network.

34. The coffee maker of claim 33, wherein the processor is configured to control the coffee product processing means to process the coffee product according to one or more control parameters received over said network in response to said exchange of information.

35. The coffee maker of claim 34, wherein the coffee maker is configured to retrieve the set of preconfigured control parameters from the server or database.

36. The coffee maker of claim 35, wherein the coffee maker is configured to retrieve the set of preconfigured control parameters from the server or database by:
receiving information identifying the coffee product and/or one or more characteristics of said coffee product at an input interface of the coffee maker;
in response to receipt of said information at the coffee maker, controlling the coffee maker to automatically send data over said network to said server, said data comprising or relating to said received information; and
in response to sending data to the server, receiving the set of preconfigured control parameters from the server or database.

37. The coffee maker of claim 35, wherein the coffee makes comprises an input interface configured to receive information identifying the coffee product and/or one or more characteristics of said coffee product.

38. The coffee maker of claim 37, wherein the coffee maker has means for automatically identifying the identity of the coffee product and/or the identity of the one or more characteristics of said coffee product.

39. The coffee maker of claim 37, wherein the input interface is configured to receive a user's changes, adjustments or modifications of any one or more of the parameters of a set of one or more parameters.

40. The coffee maker of claim 39, wherein the processor is configured to store any user changes, adjustments or modifications to any one or more of the parameters of the set of parameters such that, when the same user uses the coffee maker for processing the coffee product on a subsequent occasion, the coffee maker implements the changed, adjusted or modified set of parameters.

41. The coffee maker of claim 39, wherein the processor is configured to store said user changes, adjustments or modifications to any one or more of the set of parameters in association with a type of coffee product, a brand of the coffee product; and/or one or more characteristics of the coffee product.

42. The coffee maker of claim 39, wherein the processor is configured to store said user changes, adjustments or modifications to any one of the one or more of the set of parameters in association with a specified user of the coffee maker.

43. The coffee maker of claim 39, wherein the coffee maker is configured to send any user changes, adjustments or modifications to any one or more of the set of parameters to any one or any combination of: the server; a third party entity network device; another coffee maker; or a user selected subset of ail network connected coffee makers.

44. The coffee maker of claim 37, wherein the coffee maker is configured to receive a user's rating information for the coffee product to be consumed where said coffee product is processed according to a set of parameters and to send said rating information to any one or any combination of: the server; a third party entity network device; another coffee maker; or a user selected subset of all network connected coffee makers.

45. A method of processing a coffee product in a network connected coffee maker comprising the steps of:
connecting said coffee maker to a communications network;
exchanging information through said communications network with any one or any combination of: a server; a database; a network connected device, another coffee maker or a group of other coffee makers for processing a consumable product of a same general class or type of consumable product;
controlling a coffee product processing means of the coffee maker to process the coffee product based on information received over said network as a consequence of said exchange of information.

46. A cup for use with the coffee maker of claim 27, wherein said cup has means for wirelessly communicating with the coffee maker.
